(19) United States
(12) Patent Application Publication
(10) Pub. No.: US 2003/0024071 A1
(43) Pub. Date: Feb. 6, 2003

(54) Retractable handle device having adjustable structure

(76) Inventor: King Sheng Wang, Taichung Hsien (TW)

Correspondence Address: CHARLES E. BAXLEY, 5th Floor, 59 John Street, New York, NY, 10038, US

(21) Appl. No.: 09/920,185

(22) Filed: Aug. 2, 2001

(51) Int. Cl. E05B 7/00

(52) U.S. Cl. 16/113.1

(57) ABSTRACT

A retractable handle device includes a bracket having two openings for receiving the lower portions of two outer tubes. Two inner tubes are slidably received in the outer tubes, and a handle is secured on the top of the inner tubes. One or more pairs of sleeves of different thicknesses or areas may be engaged between the outer tubes and the bracket for snugly securing various outer tubes in the bracket. One or more pairs of barrels of different thicknesses or areas may be engaged between the inner tubes and the handle for snugly securing various inner tubes in the handle.

The present invention is related to U.S. patent application Ser. No. 09/765,707, entitled: RETRACTABLE HANDLE DEVICE HAVING A SIMPLIFIED STRUCTURE, filed Jan. 22, 2001, pending.

### BACKGROUND OF THE INVENTION

1. Field of the Invention

The present invention relates to a retractable handle assembly, and more particularly to a retractable handle assembly having an adjustable structure for adjustably securing various numbers of handle sections to the suitcase or the like.

2. Description of the Prior Art

The applicant has developed various kinds of typical retractable handle devices that have at least been disclosed in U.S. Pat. No. 5,653,319 to Wang, and U.S. Pat. No. 5,803,214 to Wang. The typical retractable handle devices may include two or more retractable handle sections that may be retracted relative to each other for carrying or moving the suitcases or the like that have different volumes or heights or widths, etc. The outermost handle sections and the innermost handle sections may thus include different lengths, and particularly may thus include different widths or diameters or areas. The manufacturers for the typical retractable handle devices are thus required to develop many mold devices for forming or manufacturing the retractable handle devices that include two or more or different retractable handle sections; i.e., the typical retractable handle devices having two, three, or more retractable sections each requires a specially designed and manufactured widths or areas for attaching the different retractable handle sections to the suitcases or the like. The mounting structures for the retractable handle devices having two, three, or more retractable sections have few parts that may be used or changed or replaced for each other.

The present invention has arisen to mitigate and/or obviate the afore-described disadvantages of the conventional retractable handle devices.

### SUMMARY OF THE INVENTION

The primary objective of the present invention is to provide a retractable handle assembly including an adjustable structure for adjustably securing various numbers of handle sections to the suitcase or the like.

In accordance with one aspect of the invention, there is provided a retractable handle assembly for attaching or mounting into or onto a suitcase or the like, and comprising a bracket including a pair of openings formed therein, a pair of first tubes including a lower portion received in the openings of the bracket respectively, a pair of second tubes slidably received in the first tubes respectively, and including an upper portion extendible upward and outward of the first tubes, a handle secured on the upper portion of the second tubes, and at least one pair of sleeves engaged in the openings of the bracket and engaged between the first tubes and the bracket for snugly receiving the lower portions of the first tubes in the bracket. The sleeves may include different thicknesses or different sizes or shapes or areas or diameters and may thus be provided and selectively engaged between the first tubes and the bracket for snugly securing the first tubes of different sizes or shapes or areas or diameters in the bracket.

One or more pairs of third tubes may further be provided and slidably engaged between the first tubes and the second tubes respectively for forming or providing a retractable handle device that has multi-handle sections, and for increasing the lengths of the retractable handle assembly.

The handle includes a pair of apertures formed therein for receiving the upper portions of the second tubes respectively.

One or more pairs of barrels may further be provided and engaged in the apertures of the handle and engaged between the second tubes and the handle for snugly receiving the upper portions of the second tubes in the handle. The barrels may include different thicknesses or different sizes or shapes or areas or diameters and may thus be provided and selectively engaged between the second tubes and the handle for snugly securing the second tubes of different sizes or shapes or areas or diameters in the handle.

An inner casing and/or an outer casing may further be provided and may each include a pair of orifices formed therein for receiving the upper portions of the second tubes respectively. The outer casing and the handle may each include a curved outer surface corresponding to the curved outer surface of the suitcase or the like.

Various kinds of actuator devices may be engaged in or provided in the tubes for controlling or for operating the retraction or the extending of the tubes relative to each other. The actuator devices are typical and are not related to the present invention.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a retractable handle assembly in accordance with the present invention;

FIG. 2 is a further partial exploded view showing more elements of the retractable handle assembly;

FIG. 3 is a partial perspective view of the retractable handle assembly; and

FIGS. 4, 5, 6 are partial cross sectional views illustrating the operation of the retractable handle assembly.

### DETAILED DESCRIPTION OF THE PREFERRED EMBODIMENT

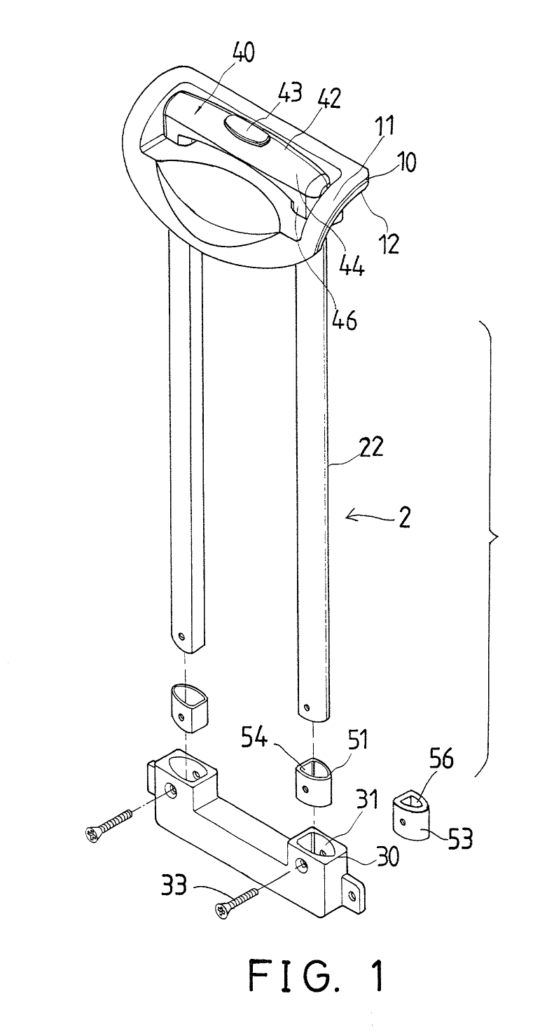

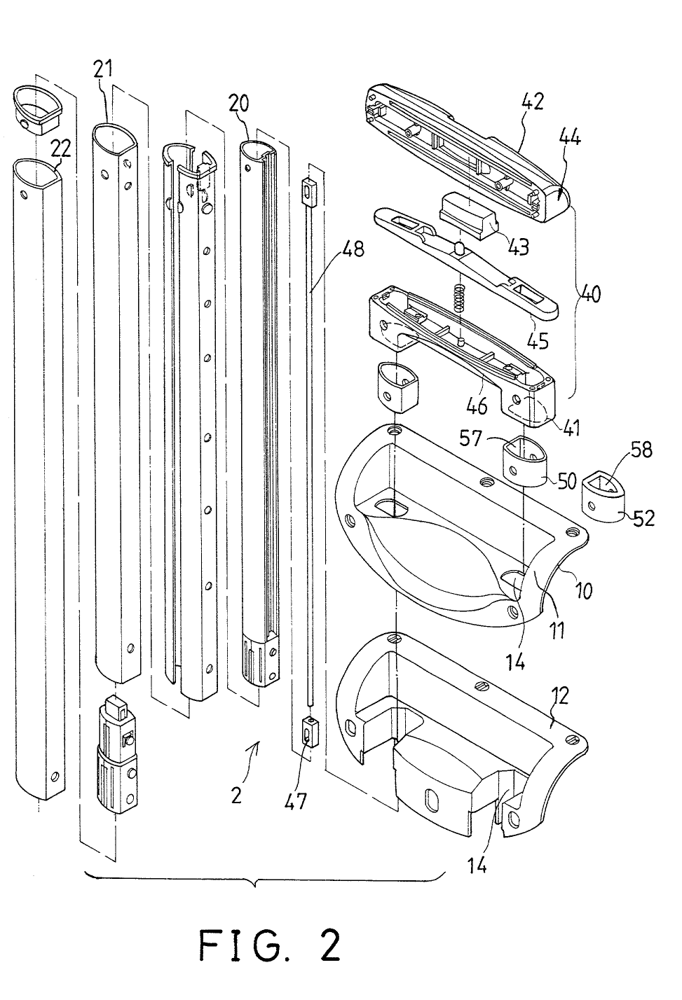

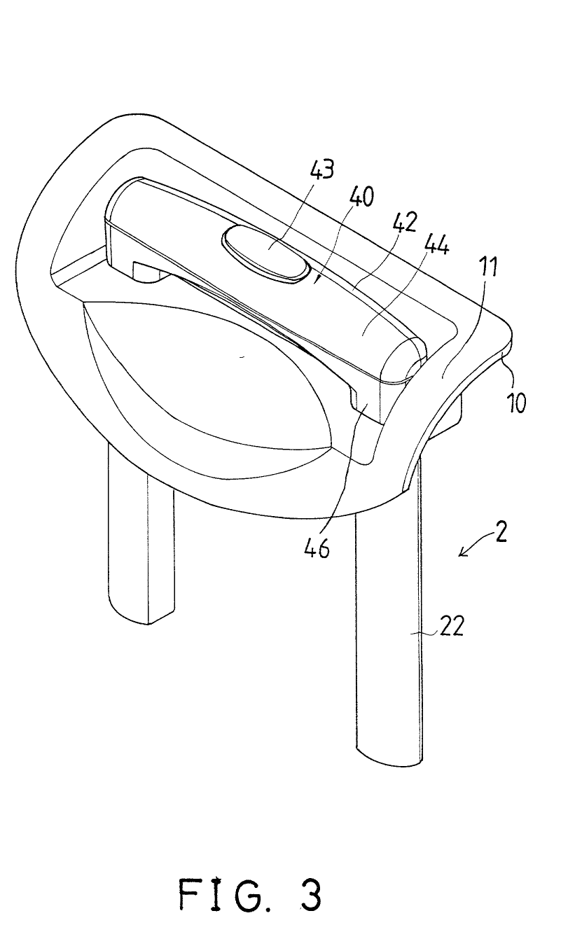

Referring to the drawings, and initially to FIGS. 1-4, a retractable handle assembly in accordance with the present invention comprises an outer casing 10 for engaging onto the outer portion of the suitcase or the like, an inner casing 12 for engaging into the inner portion of the suitcase or the like and aligned with and secured to the outer casing 10 with fasteners or the like, such that the outer casing 10 and the inner casing 12 may be secured to the upper portion of the suitcase or the like for supporting the upper portion of the retractable handle device 2. A bracket 30 may be secured to the lower portion of the suitcase or the like for supporting the lower portion of the retractable handle device 2. The retractable handle device 2 includes a pair of innermost tubes 20 slidably engaged or received in a pair of outermost tubes 22 respectively, and one or more pairs of intermediate tubes 21 slidably engaged between the innermost tubes 20 and the outermost tubes 22.

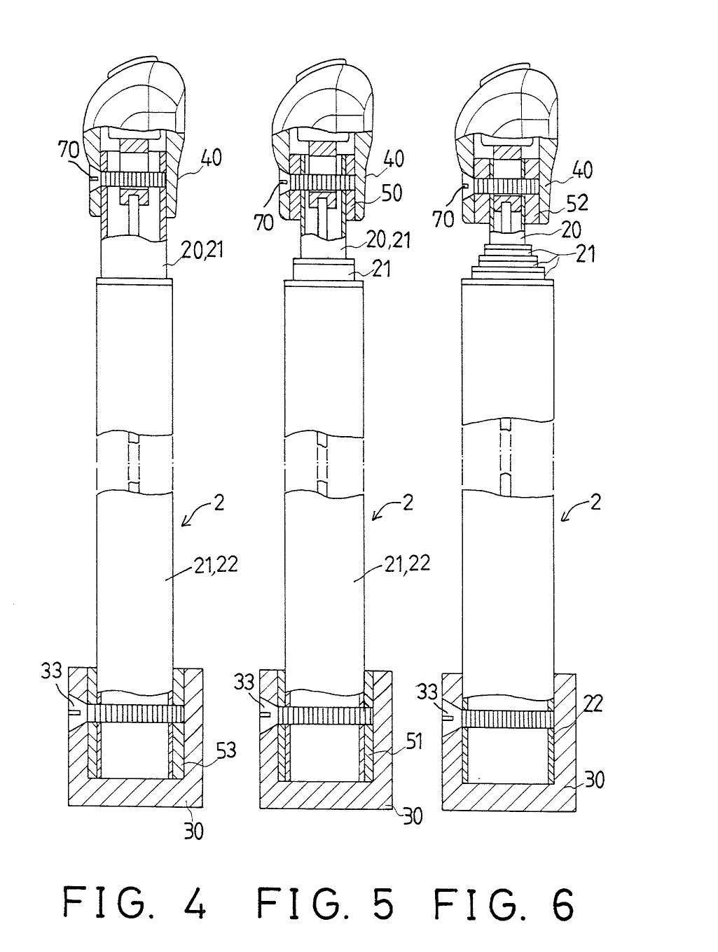

The bracket 30 includes a pair of openings 31 formed therein. The retractable handle device 2 includes a pair of outermost tubes 22 having the lower portions engaged into the openings 31 of the bracket 30 and secured to the bracket 30 with such as the fasteners 33 or the like. The openings 33 of the bracket 30 include a largest width or diameter or area large enough for receiving the lower portions of the largest or the outermost tubes 22 respectively. One or more pairs of sleeves 51, 53 may be selectively engaged into the openings 33 of the bracket 30 respectively, and each has a bore 54, 56 formed therein. The sleeves 51, 53 have an outer shape or area or diameter or width corresponding to that of the openings 33 of the bracket 30 for allowing the sleeves 51, 53 to be snugly received or force-fitted in the openings 33 of the bracket 30. The bores 54, 56 of the sleeves 51, 53 have different widths or diameters or areas for receiving the lower portions of the other tubes 20, 21 of the retractable handle device 2 or the outermost tubes 22 that have smaller widths or diameters or areas (FIGS. 4, 5). The fasteners 33 may engage through the sleeves 51, 53 and/or the tubes 22, or 21 for securing the sleeves 51, 53 and the tubes 21, 22 to the bracket 30.

The outer casing 10 and the inner casing 12 preferably include a curved outer surface 11 according to the suitcase, particularly according to the curved shape of the edge portion of the suitcase for being snugly fitted or secured onto outer portion of the suitcase. The outer casing 10 and the inner casing 12 each includes a pair of orifices 14 formed therein for receiving the upper portion of the retractable handle device 2. For example, the upper portions of the outermost tubes 22 may be engaged or received in the orifices 14 of the casings 10, 12, and may further be secured to the casings 10, 12 by fasteners or by welding processes or the like. The other tubes 21, 20 that are slidably received in the outermost tubes 22 may be pulled and extended outward of the casings 10, 12 and the outermost tubes 22 and the suitcase via the orifices 14 of the casings 10, 12.

The retractable handle device 2 includes a handle 40 secured on top of the innermost tubes 20. The handle 40 includes a base 46, and a cover 44 secured onto the base 46, with such as fasteners or by such as the welding processes, or the like, for forming an integral handle 40. A knob 43 is slidably engaged in the cover 44 and extendible upward and outward of the cover 44. The base 46 includes a pair of apertures 41 formed therein for receiving the upper ends of the innermost tubes 20 (FIGS. 4-6). The cover 44 has a curved upper or outer peripheral surface 42 formed thereon corresponding to the curved outer surface 11 of the casing 10. An actuator lever 45 is received in the handle 40 and received between the base 46 and the cover 44, and is coupled to one or more pairs of actuators 47 with cables or wires or links 48.

One example of the actuator lever 45 and the links 48 and the actuators 47 is disclosed in the co-pending U.S. patent application Ser. No. 09/765,707, entitled: RETRACTABLE HANDLE DEVICE HAVING A SIMPLIFIED STRUCTURE, filed Jan. 22, 2001, which is taken as a reference for the present application. The other examples of the actuator lever 45 and the links 48 and the actuators 47 have also been disclosed in U.S. Pat. No. 5,653,319 to Wang, and U.S. Pat. No. 5,803,214 to Wang, which also may be taken as the references for the present application. The operation of the actuator lever 45 and the links 48 and the actuators 47 is not related to the present invention and will not be described in further details.

One or more pairs of barrels 50, 52 may be selectively engaged into the apertures 41 of the base 46 of the handle 40 respectively, and each has a bore 57, 58 formed therein. The barrels 50, 52 have an outer shape or area or diameter or width corresponding to that of the apertures 41 of the base 46 of the handle 40 for allowing the barrels 50, 52 to be snugly received or force-fitted in the apertures 41 of the base 46 of the handle 40. The bores 57, 58 of the barrels 50, 52 have different widths or diameters or areas for receiving the upper portions of the other tubes 21, 22 of the retractable handle device 2 or the innermost tubes 20 that have smaller widths or diameters or areas (FIGS. 5, 6). The fasteners 70 may engage through the barrels 50, 52 and/or the tubes 20 for securing the barrels 50, 52 and the tubes 20 to the handle 40.

It is to be noted that the bracket 30 and the openings 31 of the bracket 30, and/or the handle 40 or the base 46 of the handle 40 and the apertures 41 of the handle 40 may be predeterminately formed, and may be used for receiving and attaching onto the retractable handle device 2 that have various or different handle sections or tubes 20, 21, 22. The handle sections or the tubes 20, 21, 22 may also be selectively chosen or replaced or changed with each other without changing the bracket 30 and the handle 40 to different shapes or the like.

Alternatively, or similarly, when the outermost tubes 22 have different widths or diameters or areas (FIGS. 4-6), the provision and the engagement of the sleeves 51, 53 between the bracket 30 and the outermost tubes 20 may also be used for solidly securing various kinds of outermost tubes 20 to the bracket 30. When the innermost tubes 20 have different widths or diameters or areas (FIGS. 4-6), the provision and the engagement of the barrels 50, 52 between the handle 40 and the innermost tubes 20 may also be used for solidly securing various kinds of innermost tubes 20 to the handle 40.

Accordingly, the retractable handle assembly in accordance with the present invention includes an adjustable structure for adjustably securing various numbers of handle sections to the suitcase or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A retractable handle assembly comprising:
a bracket including a pair of openings formed therein,
a pair of first tubes including a lower portion received in said openings of said bracket respectively,
a pair of second tubes slidably received in said first tubes respectively, and including an upper portion extendible upward and outward of said first tubes,
a handle secured on said upper portion of said second tubes, and
at least one pair of sleeves engaged in said openings of said bracket and engaged between said first tubes and said bracket for snugly receiving said lower portions of said first tubes in said bracket.

2. The retractable handle assembly according to claim 1 further comprising at least one pair of third tubes slidably engaged between said first tubes and said second tubes respectively.

3. The retractable handle assembly according to claim 1, wherein said handle includes a pair of apertures formed therein for receiving said upper portions of said second tubes respectively.

4. The retractable handle assembly according to claim 3 further comprising at least one pair of barrels engaged in said apertures of said handle and engaged between said second tubes and said handle for snugly receiving said upper portions of said second tubes in said handle.

5. The retractable handle assembly according to claim 1 further comprising an inner casing having a pair of orifices formed therein for receiving said upper portions of said second tubes respectively.

6. The retractable handle assembly according to claim 1 further comprising an outer casing having a pair of orifices formed therein for receiving said upper portions of said second tubes respectively.

7. The retractable handle assembly according to claim 6, wherein said outer casing includes a curved outer surface, said handle includes a curved outer surface.

8. A retractable handle assembly comprising:
a pair of first tubes,
a pair of second tubes slidably received in said first tubes respectively, and each including an upper portion extendible upward and outward of said first tubes.
a handle including a pair of apertures formed therein for receiving said upper portions of said second tubes respectively, and
at least one pair of barrels engaged in said apertures of said handle and engaged between said second tubes and said handle for snugly receiving said upper portions of said second tubes in said handle.

9. The retractable handle assembly according to claim 8 further comprising a bracket including a pair of openings formed therein, said first tubes each including a lower portion received in said openings of said bracket respectively.

10. The retractable handle assembly according to claim 9 further comprising at least one pair of sleeves engaged in said openings of said bracket and engaged between said first tubes and said bracket for snugly receiving said lower portions of said first tubes in said bracket.

11. The retractable handle assembly according to claim 8 further comprising at least one pair of third tubes slidably engaged between said first tubes and said second tubes respectively.

12. The retractable handle assembly according to claim 8 further comprising an inner casing having a pair of orifices formed therein for receiving said upper portions of said second tubes respectively.

13. The retractable handle assembly according to claim 8 further comprising an outer casing having a pair of orifices formed therein for receiving said upper portions of said second tubes respectively.

14. The retractable handle assembly according to claim 13, wherein said outer casing and said handle each includes a curved outer surface.
